(19) United States
(12) Patent Application Publication
(10) Pub. No.: US 2012/0273649 A1
(43) Pub. Date: Nov. 1, 2012

(54) SHOCK ABSORBING DEVICE

(75) Inventors: Shy Mindel, Hefer (IL); Anan Hassan, Julis (IL); David Engel, Yavne (IL); Moshe Jacob Baum, Pardes Hanna Karkur (IL)

(73) Assignee: MOBIUS PROTECTION SYSTEMS LTD., Holon (IL)

(21) Appl. No.: 13/499,845

(22) PCT Filed: Oct. 3, 2010
(86) PCT No.: PCT/IL2010/000798

§ 371 Date: Jul. 17, 2012

Related U.S. Application Data
(60) Provisional application No. 61/247,956, filed on Oct. 2, 2009.

(51) Int. Cl. B60N 2/50; F16M 13/02; B60N 2/30; F16F 7/12

(52) U.S. Cl. 248/636; 188/371

(57) ABSTRACT

A shock absorbing device adapted for mounting at a substantially vertical surface is disclosed. The aforesaid device comprises (a) vertically spaced-apart two pulleys being mechanically securable to the vertical surface; (b) an elongate member; the elongate member provided with two terminals; the member adapted for reciprocative motion along the elongate member; the member adapted for mechanically securing a subject to be protected; (c) a wire connected to the terminals of the member and tensioned through the pulleys. The device further comprises an energy absorber. The movable elongate member is mechanically secured to the vertical surface by means the energy absorber

### REFERENCE TO RELATED PUBLICATION

This application claims priority from U.S. provisional application 61/247,956, dated Oct. 2, 2009, which is hereby incorporated by reference in its entirety.

### FIELD OF THE INVENTION

The present invention relates to a shock absorbing device, and, more specifically, to a shock absorbing device provided with an energy absorber adapted for plastic deformation.

### BACKGROUND OF THE INVENTION

There is currently a great deal of interest in improving the safety of vehicles subject to mine blast loading or high impact crashes. Land mine explosions pose two serious threats to vehicle occupants. First, the mines may contain projectiles which penetrate the underside of the vehicle and strike the occupants. Secondly, the blast energy can cause very high accelerations to be imparted to the occupants. Many research efforts have centred on adding armour to the underside of a vehicle to reduce the penetration of projectiles and to either divert or absorb the energy associated with a mine blast event. However, the ultimate goal is to protect the individual occupants. The most efficient way to provide this protection, within space and weight limitations, is to provide local protection to each individual occupant.

At present almost all of the military and many of the civil helicopters in the world are equipped with crashworthy/energy absorbing seats. Several different seat suppliers have elected to offer these seats and all have used the concepts and criteria defined by the early work as documented in the referenced material. At first, most of the seats used energy absorbing devices that applied a single, fixed approximately constant, load-displacement characteristic to decelerate the occupant and are referred to as Fixed Load Energy Absorbers. This fixed load was designed for the 50th percentile seat occupant in order to maximize the effectiveness over the weight range of the users. This meant that lighter occupants received a higher deceleration level (G's) than heavier occupants, while heavier occupants received a lower deceleration but used more stroke. Thus, the lighter occupants were at a higher risk of spinal injury due to the load applied during stroking, and the heavier occupants, although decelerating at a lower level throughout the stroke, were at a higher risk of bottoming out (exhaustion of the stroke distance). To correct these weaknesses manually adjustable, or Variable Load, Energy Absorbers (VLEA) were developed to allow the occupant to adjust the energy absorber limit load to match his or her weight thus producing the same level of protection for all sizes of occupants.

It is known a seat with VLEA's alongside with other seats that use a load-displacement profile that is not constant but varies with stroke in an attempt to take advantage of the “spring-mass” characteristics of the human body and to provide a more efficient energy absorbing process. These are not variable load, but exhibit a fixed single profile load-displacement characteristic regardless of occupant weight. Consequently they are referred to as Fixed Profile Energy Absorbers. This approach has produced seats that are certified to civil standards while others, using a somewhat different approach, have been qualified for military use. Civil certification requires testing with only a 50th percentile test dummy and does not consider the range of occupant sizes that will be using the seats. Efforts to develop seats with the profiled load-deflection characteristic for military use, where testing requires use of both large and heavy as well as small and light dummies in addition to the 50th percentile, have produced differing results as explained in more detail later in this paper.

It is known a technical solution providing energy absorption called the Variable Profile Energy Absorber in which the limit loads of the profile can be increased or reduced to match the weight of each specific occupant. The ultimate device is the Automatic Energy Absorber

WO 2008/110260 ('260) discloses a safety seat for land, air, and sea vehicles. The aforesaid seat is fixed to a support frame that is fixed on a vehicle side and has at least two vertical retaining elements. Referring to FIG. 2, each vertical retaining element comprises a spring element (12) that is loosely positioned between the roof region (10) and the bottom (11) of the vehicle, said spring element being bendable transversely to the longitudinal direction thereof under stress, and in that the seat part (14) is fixed on both sides to the spring elements (12), on the one side via a retaining strip (15), which with one end thereof is fastened in the region of the front edge of the seat part (14) and extends obliquely to the longitudinal axis of the spring element (12) in the direction of the roof region (10) of the vehicle and with the other end thereof is fixed to a fastening device (17) connected to the spring element (12), and on the other side via a harness (18) fastened on one end thereof in the region of the rear edge of the seat part (14) and guided in a path similar to the spring element (12) to the fastening device (17) and connected thereto on the other end, wherein a spacer (20) for the harness (18) is disposed near the arrangement of the fastening device (17) between the harness (18) and the spring element (12).

It should be emphasized that in accordance with the technical solution taught in '260, a shock load applied to a vehicle causes oscillations of a passenger sitting on the seat part because fixation of the aforesaid seat to the support frame through the spring element. The oscillations caused by the shock can result in bodily injury of the passenger. Thus, it is a long-felt and unmet need to provide a safety seat adapted for non-elastically absorbing the applied shock energy.

### SUMMARY OF THE INVENTION

It is hence one object of the invention to disclose a shock absorbing device adapted for mounting at a substantially vertical surface. The aforesaid device comprises (a) vertically spaced-apart two pulleys being mechanically securable to the vertical surface; (b) an elongate member; the elongate member provided with two terminals; the member adapted for reciprocative motion along the elongate member; the member adapted for mechanically securing a subject to be protected; (c) a wire connected to the terminals of the member and tensioned through the pulleys.

It is a core purpose of the invention to provide the device further comprising an energy absorber. The movable elongate member is mechanically secured to the vertical surface by means the energy absorber.

A further object of the invention is to disclose the energy absorber adapted for plastic deformation in response to stresses greater than a predetermined threshold stress along the axis of the helical ribbon.

A further object of the invention is to disclose the energy absorber selected from the group consisting of a crushable column, a rolling torus, an inversion tube, a cutting shock absorber, a slitting shock absorber, a tube-and-die absorber; a rolling/flattening-a-tube absorber; a strap/rod/wire bender absorber, a wire-through-platen absorber, a deformable link absorber, an elongating a tube/strap/cable absorber, a tube flaring, a housed coiled cable absorber, a bar-through-die absorber, a hydraulic absorber, a pneumatic absorber and any combination thereof.

A further object of the invention is to disclose the energy absorber which is a cylinder with a helical cut along its axis forming a helical ribbon, the helical ribbon is adapted for plastic deformation in response to stresses greater than a predetermined threshold stress along the axis of the helical ribbon.

A further object of the invention is to disclose the elongate member provided at terminals thereof with rollers so that the elongate member is adapted for driving downwards.

A further object of the invention is to disclose a shock absorbing support for a chair adapted for mounting at a substantially vertical surface. The aforesaid chair comprises (a) at least two parallel distance bars mechanically securable to the surface in a substantially vertical position; (b) two pulleys provided at terminals of each distance bars; (c) at least two elongate members; each elongate members provided with two terminals; each elongate members adapted for reciprocative motion along corresponding elongate member; (d) wires connected to the terminals of the elongate members and tensioned through the pulleys; (e) an overhanging support adapted for supporting a seat and a back; the support secured to the movable carriages.

It is a core purpose of the invention to provide the chair further comprising at least one energy absorber; at least one pair of the elongate members are mechanically connected to the vertical surface by means the energy absorber.

A further object of the invention is to disclose the overhanging support of an integrated structure.

A further object of the invention is to disclose the overhanging support of a collapsible structure.

A further object of the invention is to disclose the overhanging support comprising a seat support; the seat support is pivoted to the elongate member, the seat support is configured for fixating in a collapsed position in a substantially vertical member and a deployed position in a substantially horizontal position.

A further object of the invention is to disclose the seat support fixated in the horizontal positions by means of at least one substantially flexible and non-stretchable strip whereat a first terminal of the strip is secured to the support and a second terminal is secured to the carriage.

A further object of the invention is to disclose a method of absorbing an object of interest against a shock. The aforesaid method comprises the steps of (a) (a) obtaining a shock absorbing device comprising (i) at least two parallel distance bars mechanically securable to a substantially vertical surface in a substantially vertical position; (ii) two pulleys provided at terminals of each distance bars; (iii) at least two movable elongate members; each elongate carriage provided with two terminals; each adapted for reciprocative motion along corresponding distance bars; (iv) wires connected to the terminals of the elongate members and tensioned through the pulleys; (b) securing the device to the vertical surface; (c) securing the object of interest to the movable elongate member; (d) undergoing the shock from below; (e) downwardly displacing the movable elongate members;

It is a core purpose of the invention to provide the step of undergoing the shock comprising reducing an effect of the shock onto the object by means of at least partially absorbing shock energy due to plastically deforming of the energy absorber.

A further object of the invention is to disclose the step of energy absorbing is performed by plastically deforming the energy absorber in response to stresses greater than a predetermined threshold of the stress.

A further object of the invention is to disclose the step of reducing the shock effect performed by the energy absorber which is selected from the group consisting of a crushable column, a rolling torus, an inversion tube, a cutting shock absorber, a slitting shock absorber, a tube-and-die absorber; a rolling/flattening-a-tube absorber; a strap/rod/wire bender absorber, a wire-through-platen absorber, a deformable link absorber, an elongating a tube/strap/cable absorber, a tube flaring, a housed coiled cable absorber, a bar-through-die absorber, a hydraulic absorber, a pneumatic absorber and any combination thereof.

A further object of the invention is to disclose the step of reducing the shock effect performed by the energy absorber which is a cylinder with a helical cut along its axis forming a helical ribbon, the helical ribbon is adapted for plastic deformation in response to stresses greater than a predetermined threshold stress along the axis of the helical ribbon.

A further object of the invention is to disclose the step downwardly displacing comprising reciprocative motion of the elongate member along the distance bar.

A further object of the invention is to disclose the step of downwardly displacing comprising sliding the elongate member along the distance bar.

A further object of the invention is to disclose the step downwardly displacing comprising driving the carriage along the elongate member on rollers.

A further object of the invention is to disclose a method of absorbing an object of interest against a shock. The aforesaid method comprises the steps of: (a) obtaining a shock absorbing support comprising (i) at least two parallel mechanically securable to a substantially vertical surface in a substantially vertical position; (ii) two pulleys provided at terminals of each distance bar; (iii) at least two elongate members; each elongate member provided with two terminals; each elongate member adapted for reciprocative motion along corresponding distance bar; (iv) wires connected to the terminals of the elongate members and tensioned through the pulleys; (v) an overhanging support adapted for supporting a seat and a back; the support secured to the movable carriages; (vi) at least one energy absorber; at least one pair of the elongate member and the corresponding movable carriage are interconnected by means the energy absorber; (b) securing the device to the vertical surface; (c) undergoing the shock from below; (d) downwardly displacing the movable carriage.

It is a core purpose of the invention to provide the step of undergoing the shock comprises reducing an effect of the shock onto the object by means of at least partially absorbing shock energy due to plastically deforming of the energy absorber.

A further object of the invention is to disclose the step of obtaining the shock absorbing device comprising a sub-step of deploying a collapsed overhanging support.

A further object of the invention is to disclose the sub-step of deploying the overhanging support comprising a sub-step of reconfiguring the overhanging support from a collapsed position in a substantially vertical member into a deployed position in a substantially horizontal position.

A further object of the invention is to disclose the sub-step of deploying the overhanging support comprising a sub-step of fixating the seat support in the horizontal positions by means of at least one substantially flexible and non-stretchable strip whereat a first terminal of the strip is secured to the support and a second terminal is secured to the carriage.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a schematic view of the safety seat taught in '260 (prior art);

FIG. 2 is a side view of the shock absorbing device;

FIG. 3 is an isometric view of the shock absorbing chair;

FIG. 4 is an isometric view of the shock absorbing chair provided with the safety belt;

FIGS. 5 and 6 are isometric views of the shock absorbing chair provided with the shock absorbing element fixed to the fixed point;

FIGS. 7a-7c are isometric views of the shock absorbing chair provided with the shock expandable absorbing assembly fixed to the fixed point; and

FIGS. 8a and 8b are exemplary designs of the chair seats.

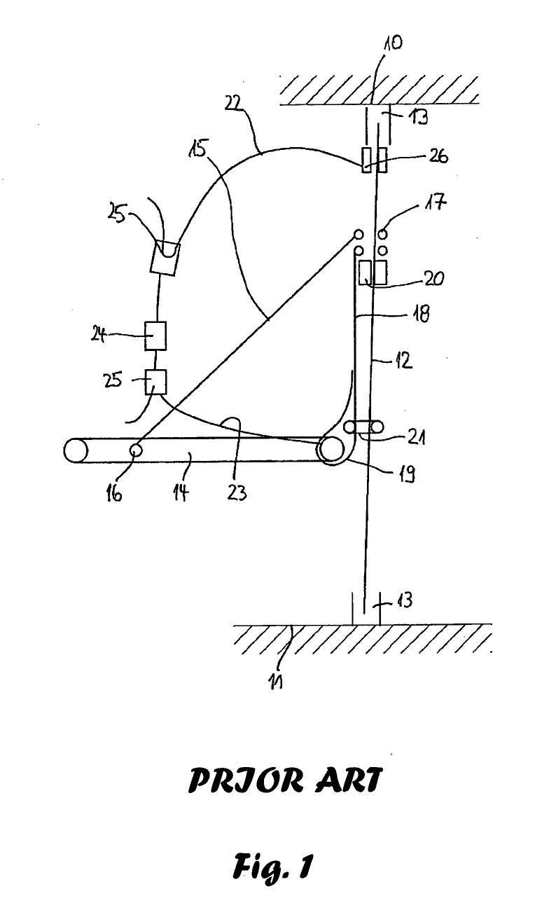

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide a shock absorbing chair and a method of using the same.

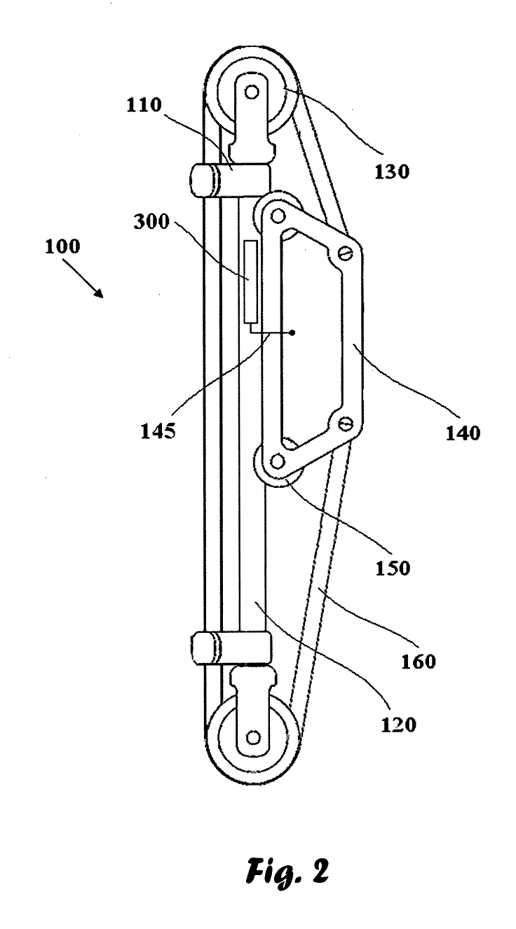

Reference is now made to FIG. 2, showing a shock absorbing device 100. The aforesaid device 100 comprises a distance bar 120 mechanically securable to a substantially vertical surface (not shown) by means of holding clips 110 which are rotatable relative to the distance bar 120. The distance bar 120 is provided with two pulleys at terminals thereof. An elongate carriage 140 is linearly movable along the distance bar 120 by means of rollers 150. An object of interest (not shown) which is to be protected against a shock (e.g. mine actuation, helicopter crash and etc.) is secured on the elongate member 140. A wire 160 tensioned around the pulleys 130 is secured to two terminals of the elongate member 140. The core innovation of the current invention is to provide an absorber 300 secured to the distance bar 120 and mechanically connected to the elongate member 140 by means a mechanical link 145. When the mine is actuated, the vehicle undergoes the shock load from below. To cushion the shock, the absorber 300 is adapted for plastic deformation, more specifically, for plastic extension which suppresses shock energy without swaying of the object of interest.

In accordance with one embodiment of the current invention, the energy absorber is a cylinder with a helical cut along its axis forming a helical ribbon. The helical ribbon is adapted for plastic deformation in response to stresses greater than a predetermined threshold stress along the axis of the helical ribbon.

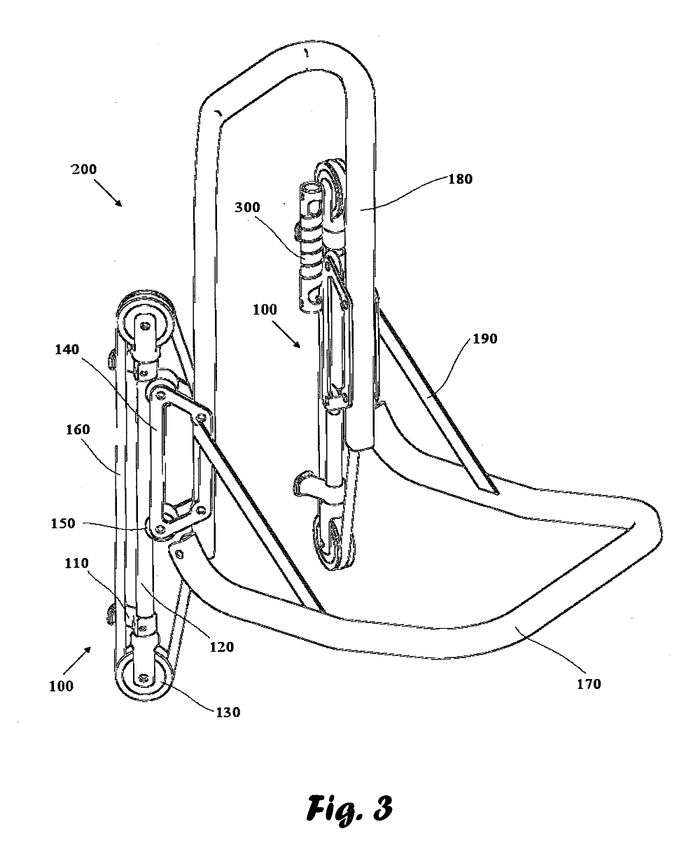

Reference is now made to FIG. 3, presenting a shock absorbing support 200 of a seat. The support comprises at least two devices 100 interconnected by a load-bearing element 180. Specifically, the element 180 connected to carriages 140. In a unlimited manner, the elements 170 and 180 are shaped into a U-like shape. The element 170 pivoted to the element 180. The elements 180 and 170 are adapted to carry a back portion and a seat portion of the chair (not shown), respectively. The element 170 can be positioned in a collapsed position in a substantially vertical member and a deployed position in a substantially horizontal position. The element 170 is optionally pivoted to the roller 150.

When the mine is actuated, the vehicle undergoes the shock load from below. Analogously with described above, the absorbers 300 are plastically deformed. More specifically, the absorbers 300 are plastically extended such that shock energy is suppressed without swaying of a passenger.

The disclosed technical solutions are characterized by light weight due to using a frame-like rigid structure and tensioned wires. The seat and back portions of the chair can be made by means of jacketing the elements 170 and 180 by a fabric, as known in prior art. Additional effect can be reached by means of using thin foam or air pillows as seat and back cushions.

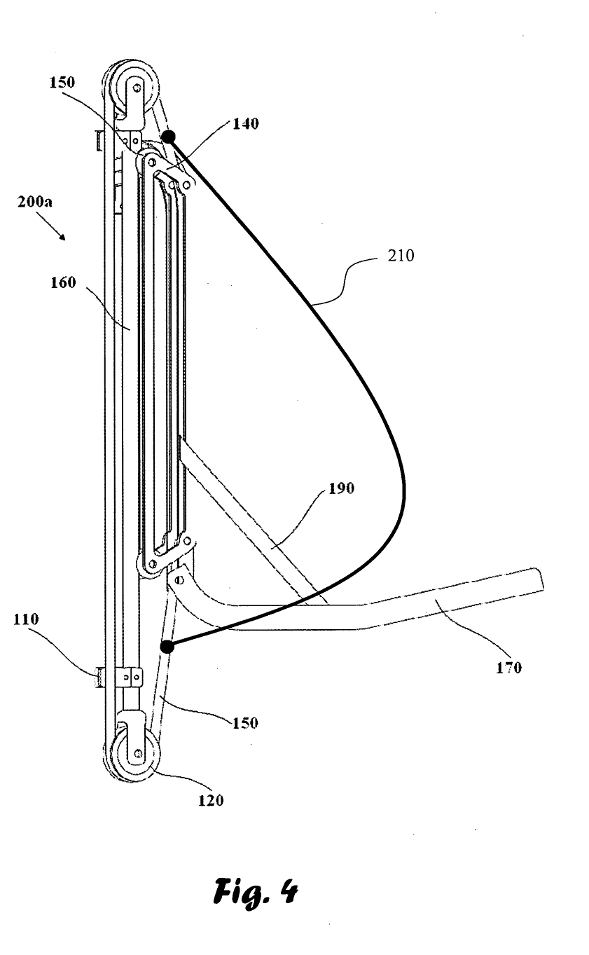

Reference is now made to FIG. 4 showing a shock absorbing device 200a provided with a safety belt 210 which keeps a passenger (not shown) it the chair.

Reference is now made to FIG. 5 showing a device 500 with the energy absorbing element 510 connected at one terminal to a fixed point. Another terminal of the energy absorbing element 510 is connected to the travelling wires, cables or belts which loop around the pulleys 520 on the stroking mechanism, brackets or housing located at the pulleys.

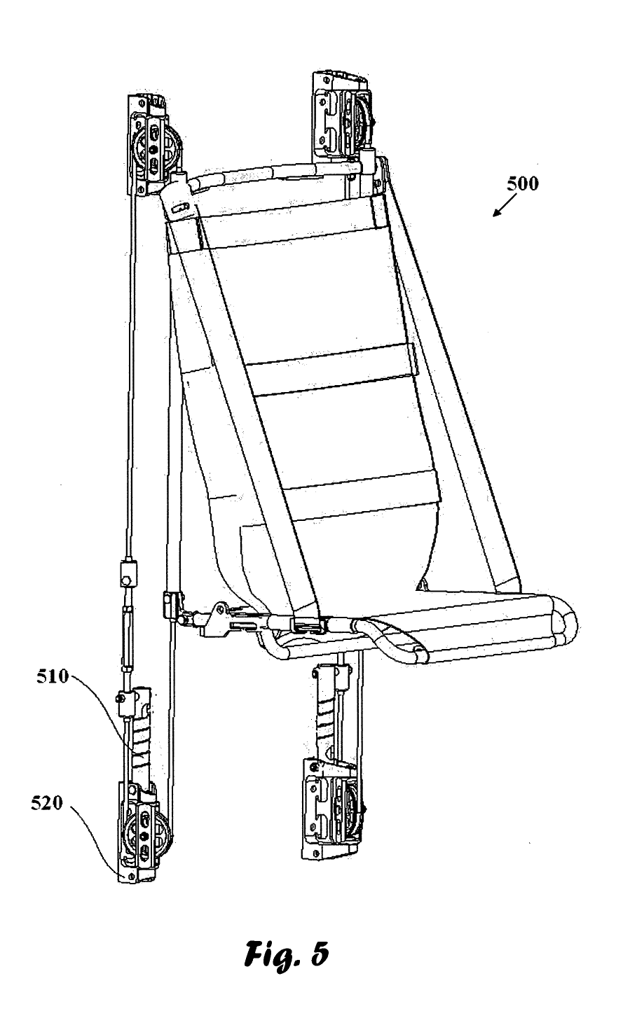

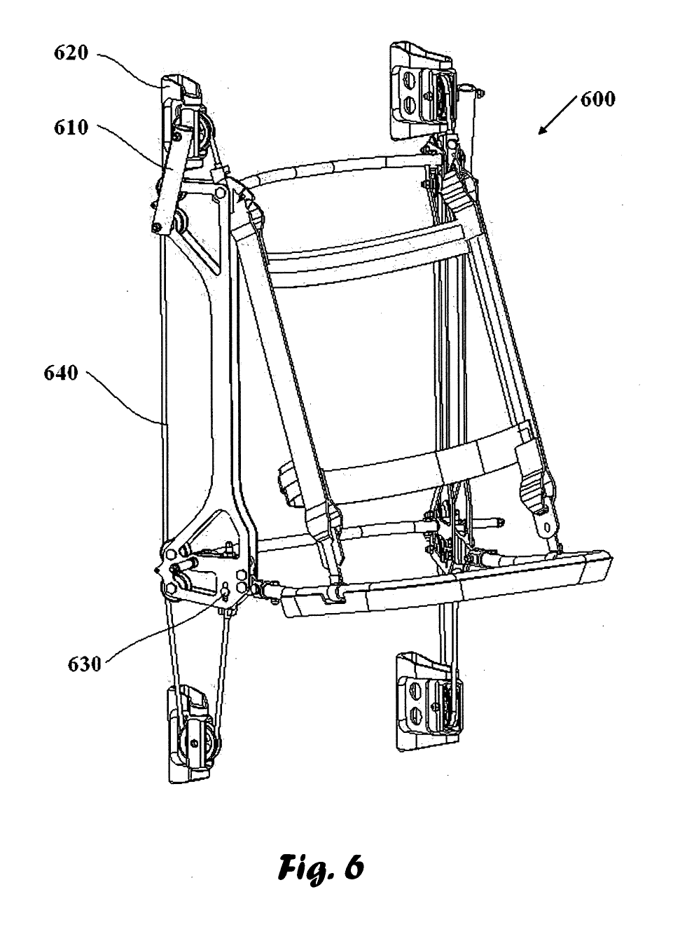

Reference is now made to FIG. 6 showing the device 600 with the energy absorbing element connected to a fixed point 610 connected to the travelling wires, cables or belts which loop around the pulleys 610 and another fixed point 620 on the stroking mechanism, brackets or housing located at the pulleys. In addition, there is a structural support 630 disposed such that the seat structure transfers part of the load to the rear wire 640

It should be noted that the absorbed energy E equals to a performed work which is a compound of the force F and the travel distance D,

E increase in the distance results in either more energy to be absorbed or lower accelerations to be transferred to the body. This gives the present invention flexibility for configurations for which exemplary embodiments are shown in the drawings and herein explained. It is acknowledged that a person skilled in the art will understand from the aforementioned how to construct and employ other embodiments which are within the scope of the present invention.

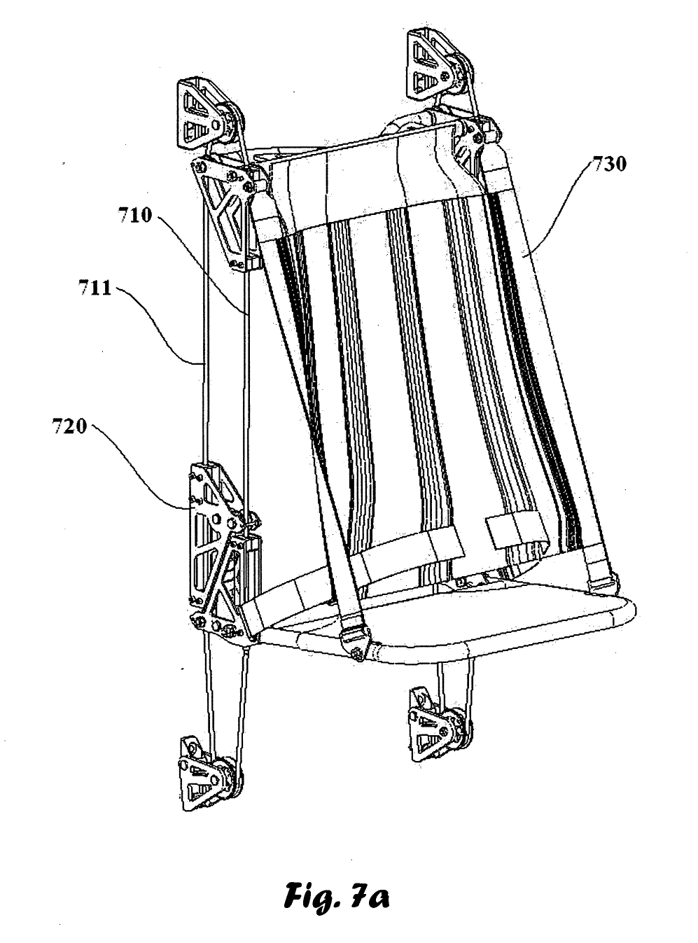

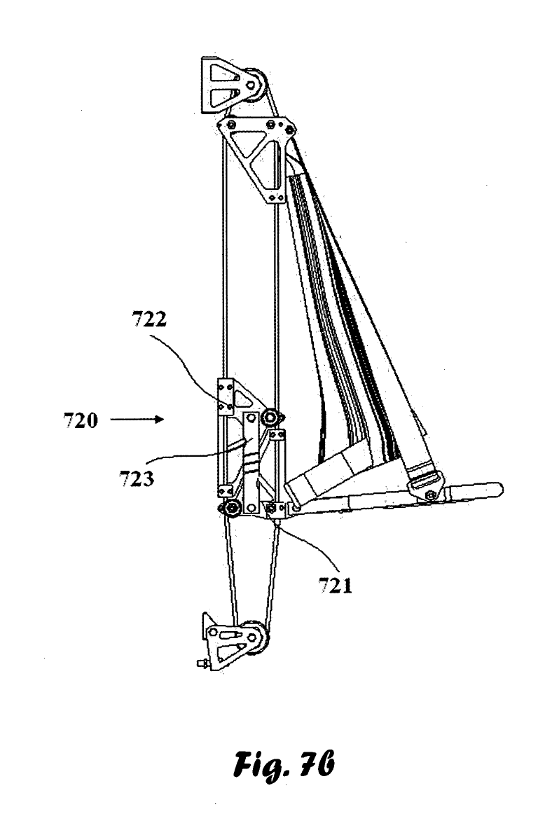

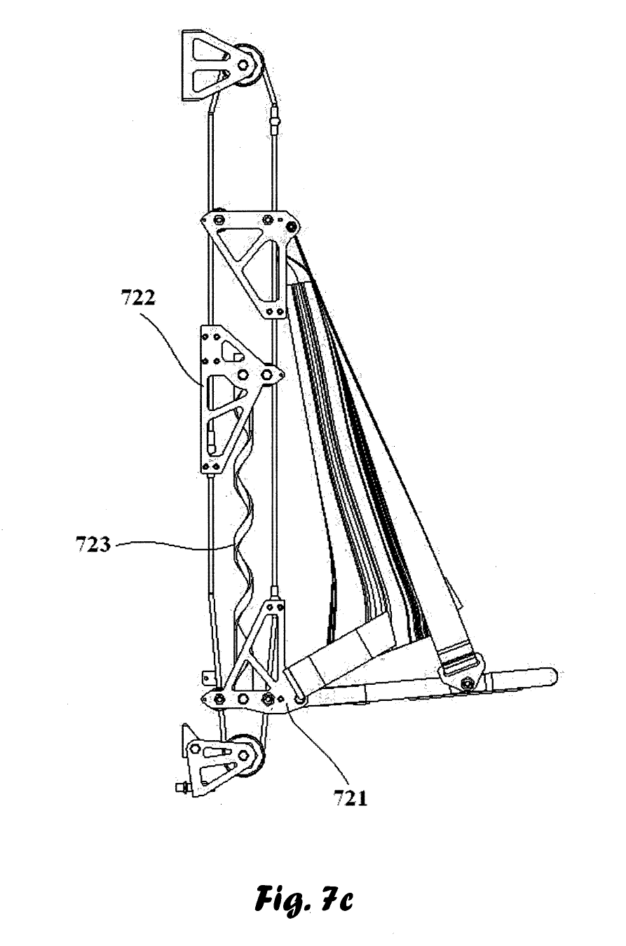

Reference is now made to FIG. 7a illustrating the system with the energy absorbing assembly 720 connecting the rear wire 711, cable or belt to the front wire, cable or belt 710. The energy absorbing assembly comprises an energy absorbing element (not shown) which is able to double it's elongation or deformation in comparison to the travel distance of the seat structure, which is connected to the seat structure support 730. The system moves or strokes down while the wires, cables or belts travel around the pulleys during the stroke, the energy absorbing element can deform or elongate in order to absorb the energy. As can be seen, there is a parallel orientation of the pulleys and cables.

FIG. 7b is a side view of the system before the stroke, showing the energy absorbing assembly 710 interconnecting to the front wire 710 and the rear wire 711. The aforesaid assembly comprises an upper portion 722, a low portion 721 and an energy absorbing element 723 interconnecting thereof.

FIG. 7c shows the situation after the load is applied, and after the downward stroke with the energy absorbing assembly 720 deformed as a consequence. Since the energy absorbing element 723 is connected to the moving parts 721 and 722, In accordance with a preferred embodiment of the current invention, the elongation/deformation distance of the energy absorbing member is twice the travel of the seat itself.

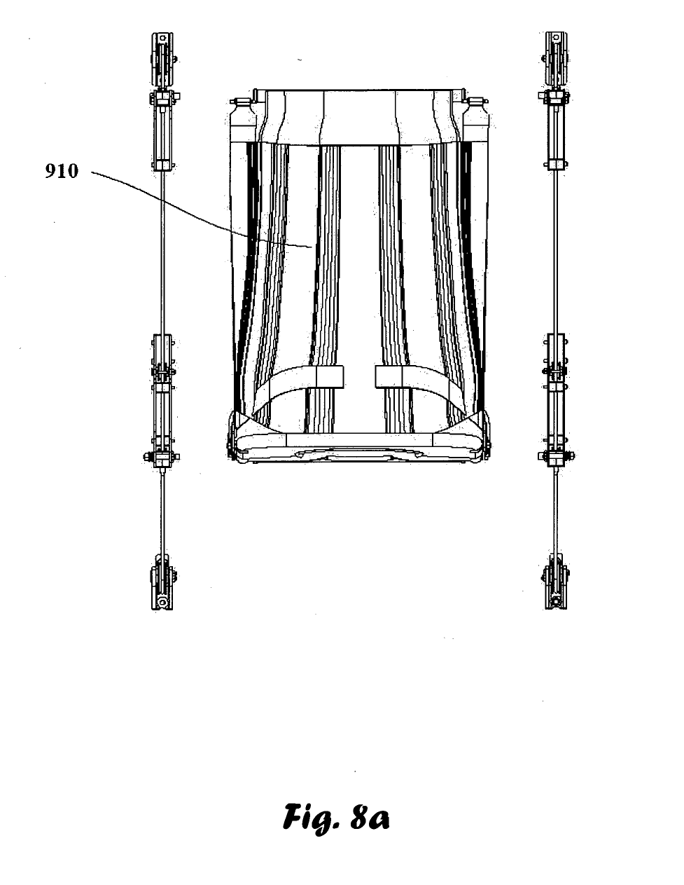

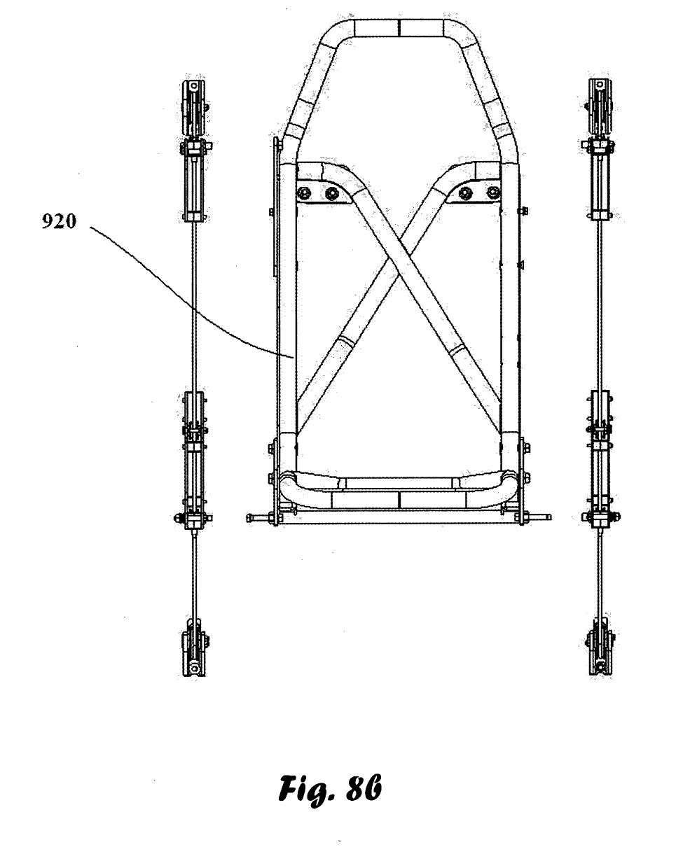

FIG. 8a shows an exemplary lightweight seat 910 for aviation platforms employing the essence of the present invention. The seat design can be independent of the stroking mechanism thus allowing flexibility in the design. The strocking mechanism and energy absorbing element on each side are independent and can be installed with any type of seat.

FIG. 8b shows an exemplary robust seat 920 for military or heavy duty platforms, employing the essence of the present invention. The seat design can be independent of the stroking mechanism thus allowing flexibility in the design. The strocking mechanism and energy absorbing element on each side are independent and can be installed with any type of seat.

It should be emphasized that the pulleys can be either parallel to the seat (see FIG. 8) or at a some angle to the seat to be able for better absorbance of side forces or with a pivoting pulley inside a base (see FIGS. 5 and 6).

In accordance with the current invention, a shock absorbing device adapted for mounting at a substantially vertical surface is disclosed. The aforesaid device comprises (a) vertically spaced-apart two pulleys being mechanically securable to the vertical surface; (b) an elongate member; the elongate member provided with two terminals; the member adapted for reciprocative motion along the elongate member; the member adapted for mechanically securing a subject to be protected; (c) a wire connected to the terminals of the member and tensioned through the pulleys.

It is a core feature of the invention to provide the device further comprising an energy absorber. The movable elongate member is mechanically secured to the vertical surface by means the energy absorber.

In accordance with one embodiment of the current invention, the vertically spaced-apart pulleys are mechanically interconnected by a distance bar.

In accordance with another embodiment of the current invention, the energy absorber is adapted for plastic deformation in response to stresses greater than a predetermined threshold stress along the axis of the helical ribbon.

In accordance with another embodiment of the current invention, the energy absorber is selected from the group consisting of a crushable column, a rolling torus, an inversion tube, a cutting shock absorber, a slitting shock absorber, a tube-and-die absorber; a rolling/flattening-a-tube absorber; a strap/rod/wire bender absorber, a wire-through-platen absorber, a deformable link absorber, an elongating a tube/strap/cable absorber, a tube flaring, a housed coiled cable absorber, a bar-through-die absorber, a hydraulic absorber, a pneumatic absorber and any combination thereof.

In accordance with another embodiment of the current invention, the energy absorber is a cylinder with a helical cut along its axis forming a helical ribbon, the helical ribbon is adapted for plastic deformation in response to stresses greater than a predetermined threshold stress along the axis of the helical ribbon.

In accordance with another embodiment of the current invention, the elongate member is adapted for sliding movement along the distance bar.

In accordance with another embodiment of the current invention, elongate member is provided at terminals thereof with rollers so that the elongate member is adapted for driving along the distance bar.

In accordance with another embodiment of the current invention, a shock absorbing support for a chair is adapted for mounting at a substantially vertical surface. The aforesaid chair comprises (a) at least two parallel distance bars mechanically securable to the surface in a substantially vertical position; (b) two pulleys provided at terminals of each distance bars; (c) at least two elongate members; each elongate members provided with two terminals; each elongate members adapted for reciprocative motion along corresponding elongate member; (d) wires connected to the terminals of the elongate members and tensioned through the pulleys; (e) an overhanging support adapted for supporting a seat and a back; the support secured to the movable carriages.

It is a core feature of the invention to provide the chair further comprising at least one energy absorber; at least one pair of the elongate members are mechanically connected to the vertical surface by means the energy absorber.

In accordance with another embodiment of the current invention, the overhanging support is of an integrated structure.

In accordance with another embodiment of the current invention, the overhanging support is of a collapsible structure.

In accordance with another embodiment of the current invention, the overhanging support comprises a seat support. The seat support is pivoted to the elongate member. The seat support is configured for fixating in a collapsed position in a substantially vertical member and a deployed position in a substantially horizontal position.

In accordance with another embodiment of the current invention, the seat support is fixated in the horizontal positions by means of at least one substantially flexible and non-stretchable strip whereat a first terminal of the strip is secured to the support and a second terminal is secured to the carriage.

In accordance with another embodiment of the current invention, a method of absorbing an object of interest against a shock is disclosed. The aforesaid method comprises the steps of (a) obtaining a shock absorbing device comprising (i) at least two parallel distance bars mechanically securable to a substantially vertical surface in a substantially vertical position; (ii) two pulleys provided at terminals of each distance bars; (iii) at least two movable elongate members; each elongate carriage provided with two terminals; each adapted for reciprocative motion along corresponding distance bars; (iv) wires connected to the terminals of the elongate members and tensioned through the pulleys; (b) securing the device to the vertical surface; (c) securing the object of interest to the movable elongate member; (d) undergoing the shock from below; (e) downwardly displacing the movable elongate members;

It is a core feature of the invention to provide the step of undergoing the shock comprising reducing an effect of the shock onto the object by means of at least partially absorbing shock energy due to plastically deforming of the energy absorber.

In accordance with another embodiment of the current invention, the step of energy absorbing is performed by plastically deforming the energy absorber in response to stresses greater than a predetermined threshold of the stress.

In accordance with another embodiment of the current invention, the step of reducing the shock effect performed by the energy absorber which is selected from the group consisting of a crushable column, a rolling torus, an inversion tube, a cutting shock absorber, a slitting shock absorber, a tube-and-die absorber; a rolling/flattening-a-tube absorber; a strap/rod/wire bender absorber, a wire-through-platen absorber, a deformable link absorber, an elongating a tube/strap/cable absorber, a tube flaring, a housed coiled cable absorber, a bar-through-die absorber, a hydraulic absorber, a pneumatic absorber and any combination thereof.

In accordance with another embodiment of the current invention, the step of reducing the shock effect performed by the energy absorber is a cylinder with a helical cut along its axis forming a helical ribbon, the helical ribbon is adapted for plastic deformation in response to stresses greater than a predetermined threshold stress along the axis of the helical ribbon.

In accordance with another embodiment of the current invention, the step downwardly displacing comprises reciprocative motion of the elongate member along the distance bar.

In accordance with another embodiment of the current invention, the step of downwardly displacing comprises sliding the elongate member along the distance bar.

In accordance with another embodiment of the current invention, the step downwardly displacing comprises driving the carriage along the elongate member on rollers.

In accordance with another embodiment of the current invention, a method of absorbing an object of interest against a shock is disclosed. The aforesaid method comprises the steps of: (a) obtaining a shock absorbing support comprising (i) at least two parallel distance bars mechanically securable to a substantially vertical surface in a substantially vertical position; (ii) two pulleys provided at terminals of each distance bar; (iii) at least two elongate members; each elongate member provided with two terminals; each elongate member adapted for reciprocative motion along corresponding distance bar; (iv) wires connected to the terminals of the elongate members and tensioned through the pulleys; (v) an overhanging support adapted for supporting a seat and a back; the support secured to the movable carriages; (vi) at least one energy absorber; at least one pair of the elongate member and the corresponding movable carriage are interconnected by means the energy absorber; (b) securing the device to the vertical surface; (c) undergoing the shock from below; (d) downwardly displacing the movable carriage.

It is a core feature of the invention to provide the step of undergoing the shock comprises reducing an effect of the shock onto the object by means of at least partially absorbing shock energy due to plastically deforming of the energy absorber.

In accordance with another embodiment of the current invention, the step of obtaining the shock absorbing device comprises a sub-step of deploying a collapsed overhanging support.

In accordance with another embodiment of the current invention, the sub-step of deploying the overhanging support comprises a sub-step of reconfiguring the overhanging support from a collapsed position in a substantially vertical member into a deployed position in a substantially horizontal position.

In accordance with another embodiment of the current invention, the sub-step of deploying the overhanging support comprises a sub-step of fixating the seat support in the horizontal positions by means of at least one substantially flexible and non-stretchable strip whereat a first terminal of the strip is secured to the support and a second terminal is secured to the carriage.

1-40. (canceled)

41. A shock absorbing device adapted for mounting at a substantially vertical surface; said device comprising
a. vertically spaced-apart two pulleys being mechanically securable to said vertical surface;
b. an elongate member; said elongate member provided with two terminals; said member adapted for reciprocative motion along said elongate member; said member being mechanically securable a subject to be protected;
c. a wire connected to said terminals of said member and tensioned, when in use, through said pulleys;
wherein said device further comprises an energy absorber; said movable elongate member is mechanically securable to said vertical surface by means of said energy absorber.

42. The shock absorbing device according to claim 41, wherein said vertically spaced-apart pulleys are mechanically interconnected by a distance bar.

43. The shock absorbing device according to claim 41 additionally comprising at least one slidable load bearing support adapted to transfer at least part of said load to the rear wire.

44. The shock absorbing device according to claim 41, wherein said energy absorber is plastically deformable in response to stresses greater than a predetermined threshold stress along said axis of said helical ribbon.

45. The shock absorbing device according to claim 44, wherein said energy absorber is a cylinder with a helical cut along axis thereof forming a helical ribbon.

46. The shock absorbing device according to claim 41, wherein said elongate member is adapted for sliding movement along said distance bar.

47. The shock absorbing device according to claim 43, wherein at least one said energy absorber interconnects the rear wire and the front wire such that said that said energy absorber is pulled in opposite directions at least during operation.

48. The shock absorbing device according to claim 41, wherein said elongate member is provided at terminals thereof with rollers so that said elongate member is adapted for driving along said distance bar.

49. A shock absorbing support for a chair mountable at a substantially vertical surface; said chair comprising
a. at least two parallel distance bars mechanically securable to said surface in a substantially vertical position;
b. two pulleys provided at terminals of each distance bars;
c. at least two elongate members; each elongate members provided with two terminals;
each elongate members adapted for reciprocative motion along corresponding elongate member;
d. wires connected to said terminals of said elongate members and tensioned through said pulleys;
e. an overhanging support adapted for supporting a seat and a back; said support securable to said movable carriages;
wherein said chair further comprises at least one energy absorber; at least one pair of said elongate members are mechanically connectable to said vertical surface by means said energy absorber.

50. The shock absorbing support according to claim 49, wherein energy absorber is adapted for plastic deformation in response to stresses greater than a predetermined threshold stress along said axis of said helical ribbon.

51. The shock absorbing device according to claim 50, wherein said energy absorber is a cylinder with a helical cut along its axis forming a helical ribbon.

52. The shock absorbing support according to claim 50, wherein said elongate member is adapted for reciprocative movement along said distance bar.

53. The shock absorbing support according to claim 52, wherein said elongate member is adapted for sliding movement along said distance bar.

54. The shock absorbing support according to claim 52, wherein said elongate member is provided at terminals thereof with rollers so that said carriage is adapted for driving along said distance bar.

55. The shock absorbing support according to claim 52, wherein said overhanging support is of a collapsible structure.

56. The shock absorbing support according to claim 49, wherein said overhanging support comprises a seat support; said seat support is pivoted to said elongate member, said seat support is configured for fixating in a collapsed position in a substantially vertical member and a deployed position in a substantially horizontal position.

57. The shock absorbing support according to claim 49, wherein said seat support is fixated in said horizontal positions by means of at least one substantially flexible and non-stretchable strip whereat a first terminal of said strip is secured to said support and a second terminal is secured to said carriage.

58. A method of absorbing an object of interest against a shock; said method comprising the steps of:
a. obtaining a shock absorbing device comprising
i. at least two parallel distance bars mechanically securable to a substantially vertical surface in a substantially vertical position;
ii. two pulleys provided at terminals of each distance bars;
iii. at least two movable elongate members; each elongate carriage provided with two terminals; each adapted for reciprocative motion along corresponding distance bars;
iv. wires connected to said terminals of said elongate members and tensioned through said pulleys;
b. securing said device to said vertical surface;
c. securing said object of interest to said movable elongate member; wherein said movable elongate member is mechanically secured to said vertical surface by means of said energy absorber; undergoing said shock from below;
d. downwardly displacing said movable elongate members;
wherein said step of undergoing said shock comprises reducing an effect of said shock onto said object by means of at least partially absorbing shock energy due to plastically deforming of said energy absorber.

59. A method of absorbing an object of interest against a shock; said method comprising the steps of:
a. obtaining a shock absorbing support comprising
i. at least two parallel distance bars mechanically securable to a substantially vertical surface in a substantially vertical position;
ii. two pulleys provided at terminals of each distance bar;
iii. at least two elongate members; each elongate member provided with two terminals; each elongate member adapted for reciprocative motion along corresponding distance bar;
iv. wires connected to said terminals of said elongate members and tensioned through said pulleys;
v. an overhanging support adapted for supporting a seat and a back; said support secured to said movable carriages;
vi. at least one energy absorber; at least one pair of said elongate member and said corresponding movable carriage are interconnected by means said energy absorber.
b. securing said device to said vertical surface;
c. undergoing said shock from below;
d. downwardly displacing said movable carriage;
wherein said step of undergoing said shock comprises reducing an effect of said shock onto said object by means of at least partially absorbing shock energy due to plastically deforming of said energy absorber.
